(19) United States
(12) Patent Application Publication
(10) Pub. No.: US 2014/0297791 A1
(43) Pub. Date: Oct. 2, 2014

(54) COMMUNICATION APPARATUS, METHOD OF CONTROLLING THE SAME, AND STORAGE MEDIUM

(71) Applicant: CANON KABUSHIKI KAISHA, Tokyo (JP)

(72) Inventor: Masamichi Tanji, Kawasaki-shi (JP)

(73) Assignee: CANON KABUSHIKI KAISHA, Tokyo (JP)

(21) Appl. No.: 14/191,569

(22) Filed: Feb. 27, 2014

(30) Foreign Application Priority Data
Mar. 28, 2013 (JP) 2013-070455

(51) Int. Cl. H04L 29/08

(52) U.S. Cl. CPC H04L 67/06
USPC 709/217

(57) ABSTRACT

A communication apparatus receives a packet, to which a sequence number is attached, from an external apparatus using UDP, determines whether or not to make a request for retransmission of a packet to the external apparatus based on the received packet, and transmits a retransmission request using TCP to the external apparatus in a case where it determines to make the request for the retransmission of the packet to the external apparatus. In a case where the apparatus transmits the retransmission request, the apparatus receives, using UDP, a packet that the external apparatus retransmitted in accordance with the retransmission request, and in a case where it is determined not to make a request for a retransmission, the apparatus transmits to the external apparatus, using TCP, a notification indicating that the packet has been normally received.

### BACKGROUND OF THE INVENTION

1. Field of the Invention

The present invention relates to a technique for communicating by a communication protocol such as UDP (User Datagram Protocol) for example.

2. Description of the Related Art

Systems exist in which image data obtained by scanning an original is transmitted from a copying machine to a server on a network, or alternatively, in which a copying machine receives and prints print data stored in a server on a network. The servers used in these kinds of systems generally are installed in the same network that the copying machine is connected to, such as a company LAN (Local Area Network).

However, in recent years, accompanying the spread and development of communication infrastructure as typified by cloud computing systems, cases are increasing in which the server exists on the Internet outside of the company LAN or at another location in the company via a VLAN. Also, because the size of the data exchanged between these kinds of copying machines and servers continues to increase, the necessity of performing communication at higher speed is increasing.

One method of communication optimization is the method of performing by UDP communication that was being performed by TCP (Transmission Control Protocol) conventionally. With TCP, after a transmitting side transmits predetermined data, it waits for an arrival confirmation reply for the transmitted data to be transmitted in reply from the receiving side. When the predetermined data is received on the receiving side, the arrival confirmation reply is transmitted in reply to the transmitting side. The transmitting side, after receiving the arrival confirmation reply, transmits the next data item. By performing an arrival confirmation exchange in this way at a predetermined timing, the reliability of data arrival is guaranteed.

In contrast to this, UDP is a protocol that omits the exchange of arrival confirmation replies as described above. The transmitting side transmits data that it wishes to transmit at its own timing, and the receiving side does not reply to the transmitting side with an arrival confirmation reply. Because of this, the wait for bidirectional communication and for arrival confirmation replies does not occur, and it is possible to perform communication at high speed. However, for communication using UDP, generally the following problems exist.

(1) There is no guarantee of data arrival.

For this reason, a data loss may occur.

(2) Bandwidth control cannot be performed.

There is the possibility that that the transmitting side, by sending a large amount of data all at once, will occupy too much bandwidth on a network, and that data will be sent exceeding the receiving capability of the receiving side.

For this reason, for transmission of data, such as scan data and print data, for which data loss is not acceptable, it is insufficient to simply change the communication protocol from TCP to UDP, and it is necessary to solve the above described problems in the processing of the application layer.

Multiple ideas for realizing guarantee of arrival in UDP-based communication have been proposed (for example, Japanese Patent Laid-Open No. 2001-339434 and Japanese Patent Laid-Open No. 2000-134263). In Japanese Patent Laid-Open No. 2001-339434, a technique is recited in which the transmitting side divides the data into the size of a UDP packet and transmits, and the receiving side returns a collective arrival confirmation reply when it receives a plurality of packets, and the transmitting side retransmits packets if the arrival confirmation reply does not arrive within a predetermined amount of time. Also, in Japanese Patent Laid-Open No. 2000-134263, sending in notification a lost sequence number when a transmitting side divides data, attaching a sequence number to each divided data item, and transmitting, and a receiving side detecting a data loss is recited.

However, with the technique of Japanese Patent Laid-Open No. 2001-339434, when a data loss occurs, the transmitting side performs the retransmission of the data at the point in time when the wait to receive the arrival confirmation reply times out. For this reason, because the time of the wait to receive the arrival confirmation reply occurs on the transmitting side, at the point in time when the data loss occurs, retransmission cannot be performed quickly. Also, it is necessary to set a time out duration appropriately in accordance with the communication partner. For example, if the time out duration is set to be short in cases of transmitting data to a partner separated by a very large distance, the possibility will exist that the time out duration will be reached before the receipt of the arrival confirmation reply. In such a case, it can be considered that the possibility of retransmissions that should be unnecessary will occur frequently, and that the communication performance will deteriorate severely. Also, conversely, when the time out duration is set to be long in cases of communication with a partner that is close, there is the possibility that the time until the retransmission initiation will be long, and the communication performance will deteriorate.

Also, in Japanese Patent Laid-Open No. 2000-134263, in an environment where, for example, data loss occurs frequently, bidirectional exchange due to notification of the sequence numbers from the receiving side will increase, and there is the possibility that an expected communication performance optimization cannot be achieved.

Accordingly, there is a need for techniques for realizing guarantee of data arrival while capitalizing on the high speed of UDP-based communication and performing retransmission of lost data quickly without drastically reducing communication performance and without putting too much load on the bandwidth on a network.

### SUMMARY OF THE INVENTION

An aspect of the present invention is to eliminate the above-mentioned problems with the conventional techniques.

A feature of the present invention is to provide a technique in which it is possible to perform communication without drastically reducing communication performance while realizing guarantee of data arrival in data communication by UDP.

According to an aspect of the present invention, there is provided a communication apparatus comprising a receiving unit configured to receive a packet, to which a sequence number is attached, from an external apparatus using UDP, a determination unit configured to determine whether or not to make a request for a retransmission of a packet to the external apparatus based on the packet received by the receiving unit, and a transmission unit configured to transmit a retransmission request using TCP to the external apparatus in a case where it is determined by the determination unit to make the request for the retransmission of the packet to the external apparatus. In a case where the transmission unit transmits the retransmission request to the external apparatus, the receiving unit receives, using UDP, a packet that the external apparatus retransmitted in accordance with the retransmission request, and in a case where it is determined by the determination unit not to make a request for a retransmission of a packet to the external apparatus, the transmission unit transmits to the external apparatus, using TCP, a notification indicating that the packet has been normally received.

According to another aspect of the present invention, there is provided a communication apparatus comprising a transmission unit configured to attach a sequence number to a packet and to transmit the packet, using UDP, to an external apparatus, and a receiving unit configured to receive, using TCP, from the external apparatus a reply corresponding to the packet transmitted by the transmission unit. In a case where the receiving unit received, from the external apparatus, a retransmission request requesting a retransmission of a packet, the transmission unit executes a retransmission of the packet using UDP.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view for showing a configuration of a communication system including communication apparatuses according to a first embodiment of the present invention.

FIG. 2 is a block diagram for showing a hardware configuration of the communication apparatus according to the first embodiment.

FIG. 3 is a functional block diagram for explaining a software configuration of the communication apparatus according to the first embodiment.

FIG. 4 is a flowchart for describing data transmitting processing by the communication apparatus according to the first embodiment.

FIG. 5 is a flowchart for describing pre-transmission negotiation processing of step S401 of FIG. 4.

FIG. 6 is a flowchart for describing sub-data transmission processing that the communication apparatus executes in step S403 according to the first embodiment.

FIG. 7 is a flowchart for describing data reception processing by the communication apparatus according to the first embodiment.

FIG. 8 is a flowchart for describing pre-reception negotiation processing that a data communication control module of the communication apparatus executes in step S701 according to the first embodiment.

FIG. 9 is a flowchart for describing sub-data reception processing that the data communication control module of the communication apparatus executes in step S702 according to the first embodiment.

FIG. 10 is a sequence diagram for showing a retransmission request mode (pattern A) of the communication apparatus according to a second embodiment of the present invention.

FIG. 11 is a sequence diagram for showing a retransmission request mode (pattern B) of the communication apparatus according to the second embodiment of the present invention.

FIG. 12 is a sequence diagram for showing a retransmission request mode (pattern C) of the communication apparatus according to the second embodiment of the present invention.

FIG. 13 is a sequence diagram for showing a retransmission request mode (pattern D) of the communication apparatus according to the second embodiment of the present invention.

FIG. 14 is a functional block diagram for explaining a software configuration of the communication apparatus according to the second embodiment.

FIG. 15 is a view for showing an example of a retransmission request mode pattern table according to the second embodiment.

FIG. 16 is a flowchart for describing data division information determination processing that the data communication control module of the communication apparatus executes according to embodiments.

FIG. 17 is a view for showing an example of a communication environment diagnosis result table according to embodiments.

### DESCRIPTION OF THE EMBODIMENTS

Embodiments of the present invention will be described hereinafter in detail, with reference to the accompanying drawings. It is to be understood that the following embodiments are not intended to limit the scope of the claims of the present invention, and that not all of the combinations of the aspects that are described according to the following embodiments are necessarily required with respect to the means to solve the problems according to the present invention.

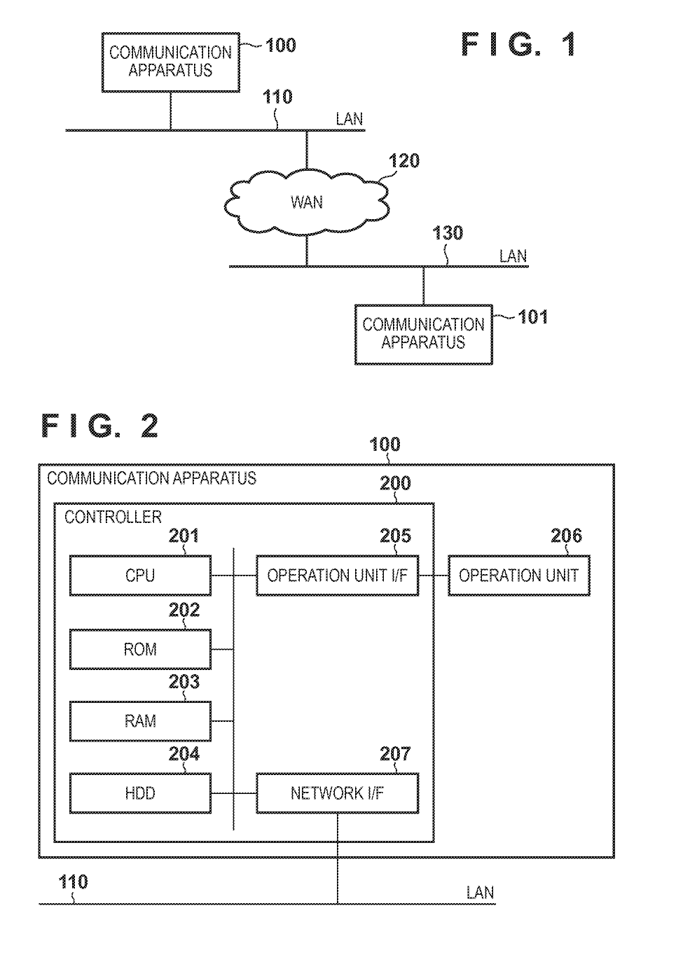

FIG. 1 is a view for showing a configuration of a communication system including a communication apparatus according to a first embodiment of the present invention.

A communication apparatus 100 is connected to a LAN 110 and a communication apparatus 101 is connected to a LAN 130. The LAN 110 and the LAN 130 are connected to each other via a WAN (Wide Area Network) 120. Accordingly, the communication apparatus 100 and the communication apparatus 101 can perform data transmission and receiving with each other via the LANs 110, 130 and the WAN 120. Note, in this embodiment, while the communication apparatus 100 and the communication apparatus 101 each exist on a separate LANs, they do not necessarily have to exist on separate LANs. In other words, it is possible to take a configuration in which the communication apparatus 100 and the communication apparatus 101 exist on the same LAN, and perform direct communication without going through the WAN 120.

FIG. 2 is a block diagram for showing a hardware configuration of the communication apparatuses 100 and 101 according to the first embodiment. Note, because the hardware configuration of the communication apparatus 101 is the same as the configuration shown in FIG. 2, explanation will be given for the communication apparatus 100 only.

A controller 200, including a CPU 201, controls the operation of the communication apparatus 100 on the whole. The CPU 201 executes various control processing such as communication control according to embodiments in accordance with a control program loaded into a RAM 203 from an HDD 204. A ROM 202 stores a boot program and various setting information. When an electric power of the communication apparatus 100 is turned on, the CPU 201 executes a boot program stored in the ROM 202, reads out an OS, various control programs, and the like installed in the HDD 204, and loads them into the RAM 203. After that, by the CPU 201 executing the programs loaded into the RAM 203, the communication apparatus 100 is activated. The RAM 203 is used as a temporary storage area such as a main memory of the CPU 201, a work area, or the like. The HDD 204 stores data, various programs, or various information tables. An operation unit I/F 205 controls an interface between an operation unit 206 and the controller 200. The operation unit 206 is provided with a display unit having a touch panel function, a keyboard or the like. A network I/F 207 connects the controller 200 (the communication apparatus 100) to the LAN 110. The network I/F 207 transmits information to external apparatuses (for example, the communication apparatus 101) on the LAN 110, the LAN 130, or the like, or receives various information from external apparatuses.

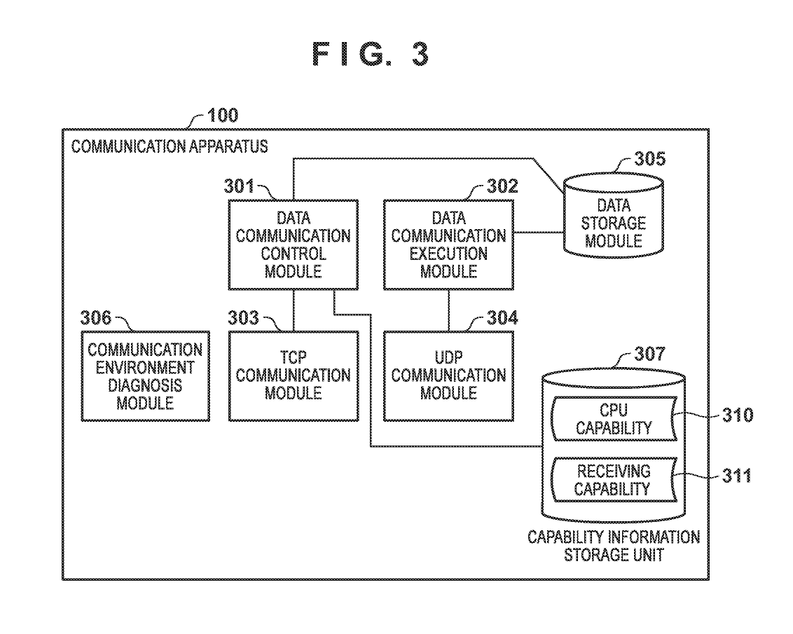

FIG. 3 is a functional block diagram for explaining a software configuration of the communication apparatuses 100 and 101 according to the first embodiment. Note, each functional unit shown in FIG. 3 is realized by the CPU 201 executing the control programs of the communication apparatus 100.

The communication apparatus 100 has a data communication control module 301, a data communication execution module 302, a TCP communication module 303, a UDP communication module 304 and a data storage module 305. The data communication control module 301 controls data communication that the data communication execution module 302 executes with external apparatuses such as the communication apparatus 101, for example. The data communication execution module 302 performs exchange of data with external apparatuses such as the communication apparatus 101, for example. The TCP communication module 303 performs communication using TCP with external apparatuses such as the communication apparatus 101, for example. The data communication control module 301 is an application that operates on top of the TCP communication module 303. The UDP communication module 304 performs communication with external apparatuses such as the communication apparatus 101, for example, using UDP. The data communication execution module 302 is an application that operates on top of the UDP communication module 304. The data storage module 305 stores data that the data communication execution module 302 transmitted to or received from external apparatuses, references data stored according to an instruction from the data communication control module 301 or the data communication execution module 302, or stores specified data.

A communication environment diagnosis module 306 performs a diagnosis of a communication environment for communication with an external communication apparatus specified by a user in accordance with an instruction of the user input via the operation unit 206. Here the items for which the diagnosis is performed are the RTT for communication with the target communication apparatus (round trip delay time: Round Trip Time), and the packet loss rate. The communication environment diagnosis module 306 transmits a predetermined number of existence confirmation packets having responsiveness to the target communication apparatus, for example. Times that it takes from the transmission of existence confirmation packets until the receipt of the corresponding reply packets are measured, and the RTT is measured by calculating the average value. Also, by comparing the number of existence confirmation packets transmitted and the number of reply packets received, the packet loss rate can be obtained.

For example, the existence confirmation packet is an ICMP (Internet Control Message Protocol) Echo request packet, and the reply packet is an ICMP Echo reply packet. Alternatively, the existence confirmation packet and the reply packet may be of an independently created application using another protocol.

A capability information storage unit 307 stores capability information 310 of the CPU 201, receiving capability information 311 in the communication, and the like. The capability information 310 of the CPU 201 maintains a numeric value for an operating clock frequency of the CPU 201. Also, the receiving capability information 311 maintains a memory size that the data communication execution module 302 is able to allocate for the reception processing, a reception buffer size that the UDP communication module 304 is able to allocate and occupy for the data communication execution module 302. Furthermore, the receiving capability information 311 maintains information (10BASE, 100BASE, etc.) of the communication rate at which the network I/F 207, which is a physical layer, is operating currently. Note, the communication apparatus 101 similarly is provided with the software configuration shown in FIG. 3.

In the first embodiment, explanation will be given providing an example in which data is transferred from the communication apparatus 101 to the communication apparatus 100 in a configuration as above.

Specifically, explanation will be given for cases in which data stored in the data storage module 305 of the communication apparatus 101 is transmitted, by communication using UDP, from the communication apparatus 101 to the communication apparatus 100, and stored in the data storage module 305 of the communication apparatus 100. Also, this transmitting is initiated by a user making an instruction to receive the data from the operation unit 206 of the communication apparatus 100.

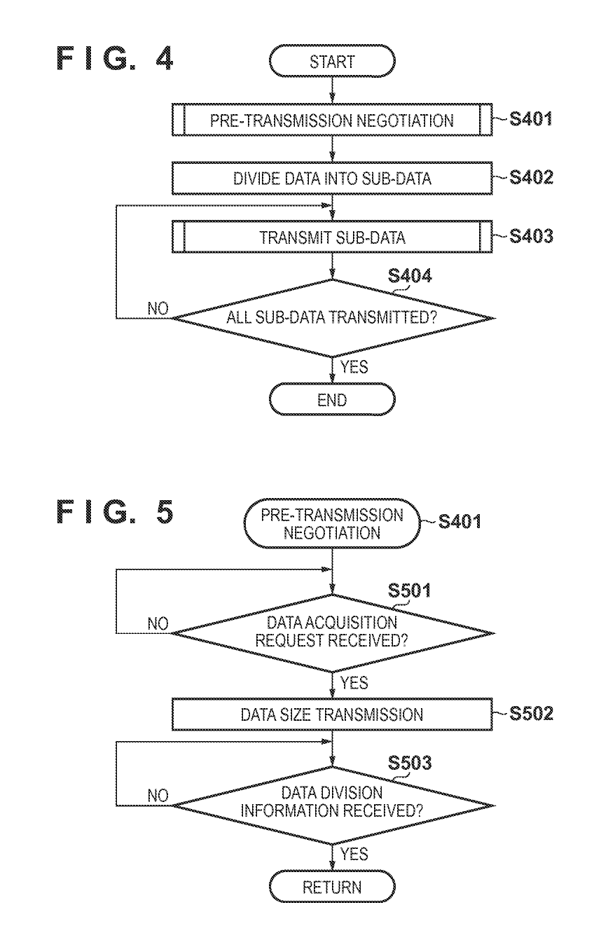

FIG. 4 is a flowchart for describing data transmitting processing by the communication apparatus 101 according to the first embodiment. Steps S401-S404 indicate the processing steps corresponding to a flow for data transmitting processing that the communication apparatus 101 performs. Note, a program for executing the control procedure shown in this flowchart may be stored in any of the ROM 202, the RAM 203 or the HDD 204 of the communication apparatus 101, and by the CPU 201 executing the program, the control procedure is executed.

Firstly, in step S401, the data communication control module 301 of the communication apparatus 101 executes pre-transmission negotiation processing.

FIG. 5 is a flowchart for describing the pre-transmission negotiation processing of step S401 of FIG. 4. Steps S501-S503 indicate the processing steps corresponding to a flow for pre-transmission negotiation processing that the data communication control module 301 of the communication apparatus 101 performs.

Firstly, in step S501, the data communication control module 301 of the communication apparatus 101 waits for the receipt of a data acquisition request from an external communication apparatus via the TCP communication module 303. In the first embodiment, the data acquisition request is received by the communication apparatus 100. When the data acquisition request is received, the processing proceeds to step S502, and the data communication control module 301 references the data storage module 305, confirms the requested size of the data of the transmission target stored in it, and this data size is transmitted to the communication apparatus 100 via the TCP communication module 303.

Next, the processing proceeds to step S503, and the data communication control module 301 of the communication apparatus 101 waits for the receipt of the data division information from the communication apparatus 100 via the TCP communication module 303. The data division information is something that the communication apparatus 100 requests of the communication apparatus 101 in order that, for example, in a case where the size of the data notified in step S502 is 5 megabytes, the data items each be divided into five 1 megabyte sub-data items and transmitted. When the data division information is received, the flowchart of this subroutine completes.

In this way, in step S401, when the processing of the subroutine shown in FIG. 5 is executed, the processing proceeds to step S402, and the data communication execution module 302 of the communication apparatus 101 acquires the requested data by reading it out from the data storage module 305. In accordance with the data division information is received in step S503 of FIG. 5, the data is divided into a plurality of sub-data items. Then, the processing proceeds to step S403, sub-data transmission processing is executed, and one of the sub-data items out of the divided sub-data is transmitted to the communication apparatus 100. This sub-data transmission processing will be explained later in detail. In step S404, the data communication execution module 302 of the communication apparatus 101 transmits the sub-data items sequentially, and determines whether or not the transmission of all of the sub-data items has completed, and in a case where a yet to be transmitted sub-data item exists, the processing returns to step S403, and the previously described processing is executed. In a case where the transmission of all of the sub-data items has completed, the flowchart completes.

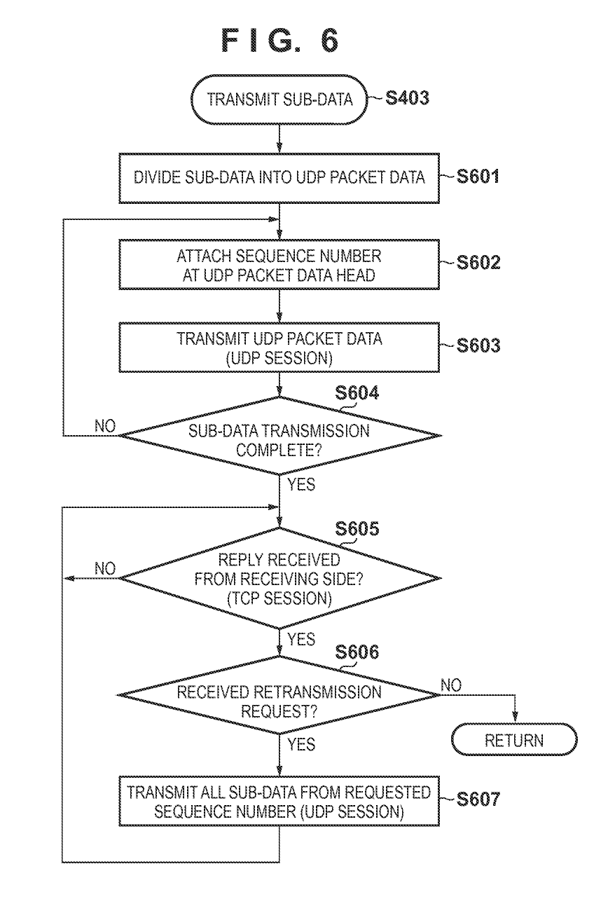

FIG. 6 is a flowchart for describing sub-data transmission processing that the communication apparatus 101 executes in step S403 according to the first embodiment. Steps S601-S607 indicate the processing steps corresponding to a flow for the sub-data transmission processing that the communication apparatus 101 performs.

The data communication execution module 302 of the communication apparatus 101 firstly, in step S601, further divides the sub-data items to be transmitted into UDP packet data of a particular size. The UDP packet data can be of any size, but it is advantageous to make the size such that a final Ethernet frame packet fits into an MTU (Maximum Transmission Unit) in the communication path for communication with the communication apparatus 100, for example.

Next, the processing proceeds to step S602, and the data communication execution module 302 of the communication apparatus 101 attaches a sequence number indicating an order of the packet data at the head of each UDP packet data item. Then the processing proceeds to step S603, and the data communication execution module 302 of the communication apparatus 101 transmits the UDP packet data to the communication apparatus 100 via the UDP communication module 304. Then the processing proceeds to step S604, and the data communication execution module 302 of the communication apparatus 101 determines whether all of the UDP packet data corresponding to the sub-data items have been transmitted, and in a case where a yet to be transmitted UDP packet data item exists, the processing returns to step S602, and the previously described processing is executed.

In step S604, in a case where the transmission of all of the sub-data items has completed, the processing proceeds to step S605, and the data communication control module 301 of the communication apparatus 101 waits for the receipt of a reply from the communication apparatus 100 via the TCP communication module 303. In step S605, when the reply is received from the communication apparatus 100, the processing proceeds to step S606, and the data communication control module 301 of the communication apparatus 101 determines whether or not the reply is a retransmission request packet. Here, in the retransmission request packet, the sequence number of the UDP packet data item for which the communication apparatus 100 requests retransmission is stored. In a case where in step S606, what was received is not the retransmission request packet, but rather an arrival confirmation packet indicating that the communication apparatus 100 received all of the sub-data items, the processing of this subroutine completes.

On the other hand, when the retransmission request packet is received in step S606, the processing proceeds to step S607, and the data communication execution module 302 of the communication apparatus 101 retransmits all of the UDP packet data items from the sequence number specified in the retransmission request packet via the UDP communication module 304 to the communication apparatus 100. Then once again the processing returns to step S605, and the reply from the communication apparatus 100 is awaited.

Next, explanation will be given for data reception processing by the communication apparatus 100 according to the first embodiment.

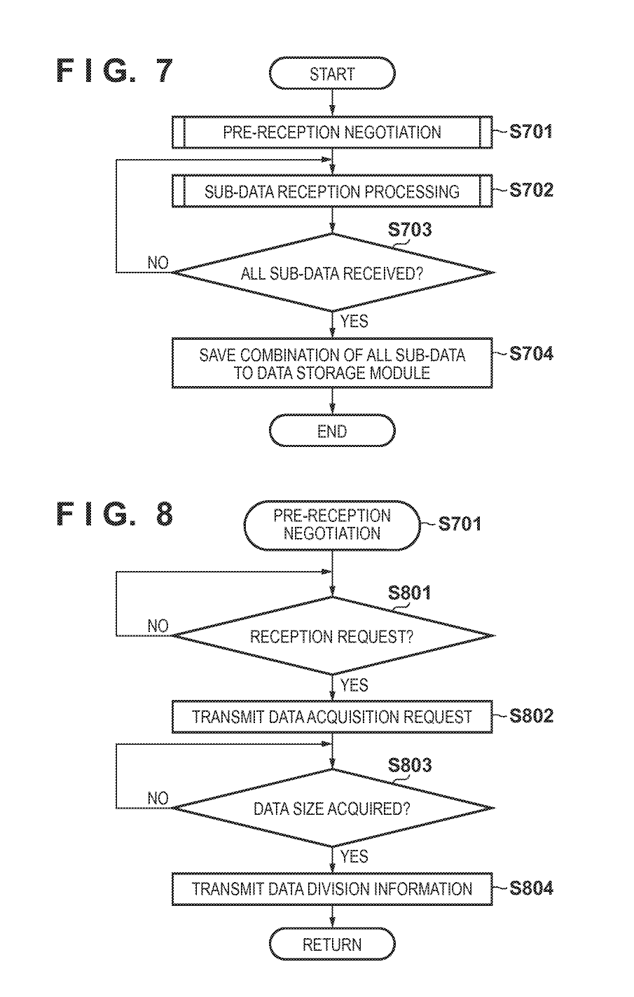

FIG. 7 is a flowchart for describing data reception processing by the communication apparatus 100 according to the first embodiment. Steps S701-S704 indicate the processing steps corresponding to a flow for data reception processing that the communication apparatus 100 performs. Note, a program for executing the control procedure shown in this flowchart may be stored in any of the ROM 202, the RAM 203 or the HDD 204 of the communication apparatus 100, and by the CPU 201 executing the program, the control procedure is executed.

Firstly, in step S701, the data communication control module 301 of the communication apparatus 100 executes pre-reception negotiation processing. The pre-reception negotiation subroutine will be explained later in detail. Next, the processing proceeds to step S702, and the data communication execution module 302 of the communication apparatus 100 executes the sub-data reception processing. The sub-data reception processing will also be explained later in detail. Next the processing proceeds to step S703, the data communication execution module 302 of the communication apparatus 100 determines whether or not all of the sub-data items have been received, and in a case where the sub-data items were not yet all received, the processing returns to step S702 and the next sub-data reception processing is performed. Meanwhile, in a case where it is determined that reception of the sub-data items has completed in step S703, the processing proceeds to step S704, and the data communication execution module 302 of the communication apparatus 100 saves data that combines all of the received sub-data items to the data storage module 305 of the communication apparatus 100, and the processing completes.

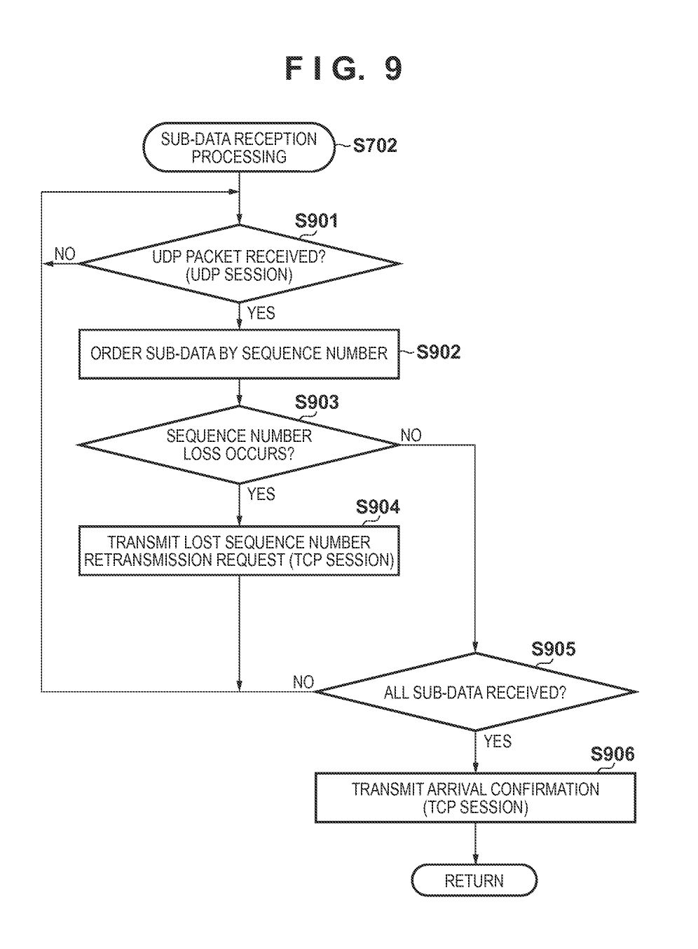

FIG. 8 is a flowchart for describing pre-reception negotiation processing that the data communication control module 301 of the communication apparatus 100 executes in step S701 according to the first embodiment. Steps S801-S804 indicate the processing steps corresponding to a flow for pre-reception negotiation processing that the data communication control module 301 of the communication apparatus 100 performs. Note, the processing shown in this flowchart is complementary to the pre-transmission negotiation processing shown in FIG. 5 that the data communication control module 301 of the communication apparatus 101 performs.

Firstly, in step S801, the data communication control module 301 of the communication apparatus 100 waits for the user to input a data acquisition request from the operation unit 206. Here, when it is detected that the data acquisition request is input the processing proceeds to step S802. In step S802, the data communication control module 301 of the communication apparatus 100 transmits via the TCP communication module 303 of the communication apparatus 100 a data acquisition request instructed by the user to the external communication apparatus (the communication apparatus 101 in the first embodiment) instructed by the user. Next, the processing proceeds to step S803, and the data communication control module 301 of the communication apparatus 100 waits for the receipt of the data size information from the communication apparatus 101 via the TCP communication module 303. In step S803, when the data size information is received, the processing proceeds to step S804, and the data communication control module 301 of the communication apparatus 100 determines in what way to divide the data into sub-data based on the size information, and whether to have the communication apparatus 101 transmit data. Then, the data communication control module 301 of the communication apparatus 100 transmits the data division information of the determination result to the communication apparatus 101 via the TCP communication module 303. After the above processing is executed, the processing of the subroutine completes.

Note, it is necessary that the communication apparatus 100 sends notification to the communication apparatus 101 of an appropriate division size in the data division information. Here, if a value that is too large is sent in notification as the division size, the possibility may arise that data loss will occur frequently when sub-data is received at the communication apparatus 100. Meanwhile, if a value that is too small is sent in notification as the division size, it is expected that the communication optimization due to the employment of UDP communication will not be sufficiently achieved. Accordingly, it is necessary to determine an optimal division size at which frequent occurrence of data loss is avoided and communication optimization is realizable, and notify the communication apparatus 101 of it. However, an optimal division size is dependent upon a CPU capability and a receiving capability of the communication apparatus 100 and these differ for each device. Furthermore, because the communication environment has an influence, there does not exist a value in the devices which is always optimal. So, it is necessary for the communication apparatus 100 to determine the division size having taken into consideration the above described factors. The processing for determining the division size will be explained later.

FIG. 9 is a flowchart for describing sub-data reception processing that the data communication control module 301 of the communication apparatus 100 executes in step S702 according to the first embodiment. Note, the flowchart is complementary to the sub-data transmission processing shown in FIG. 6 that the communication apparatus 101 performs.

Firstly, in step S901, the data communication execution module 302 of the communication apparatus 100 waits for the receipt of the UDP packet data item from the communication apparatus 101 via the UDP communication module 304. When the UDP packet data item is received, the processing proceeds to step S902, and the data communication execution module 302 of the communication apparatus 100 orders the portion of the data for which the sequence numbers are removed in increasing order of the sequence numbers, and returns to the original sub-data items. Next, the processing proceeds to step S903, and the data communication execution module 302 of the communication apparatus 100 determines whether a loss occurs in the received sub-data (whether the received UDP packet data sequence numbers are non-consecutive). Here, when it is determined that a loss occurs, the processing proceeds to step S904, and the data communication control module 301 of the communication apparatus 100 transmits a retransmission request packet in which the lost sequence number is stored to the communication apparatus 101 via the TCP communication module 303. The, the processing returns to step S901, and the next reception of UDP packet data is awaited.

Meanwhile, in a case where it is determined that a loss does not occur in the sub-data in step S903, the processing proceeds to step S905, and the data communication execution module 302 of the communication apparatus 100 determines whether the all of the sub-data items have been received, i.e. whether reception of all of the sub-data has completed. In a case where reception of the sub-data items has yet to be completed, the processing returns to step S901, and the next reception of UDP packet data is awaited. Meanwhile, in a case where it is determined that reception of the sub-data has completed in step S905, the processing proceeds to step S906, and the data communication control module 301 of the communication apparatus 100 transmits to the communication apparatus 101 via the TCP communication module 303 an arrival confirmation packet indicating reception of all of the sub-data items. After the above processing flow is executed, the processing of the subroutine completes.

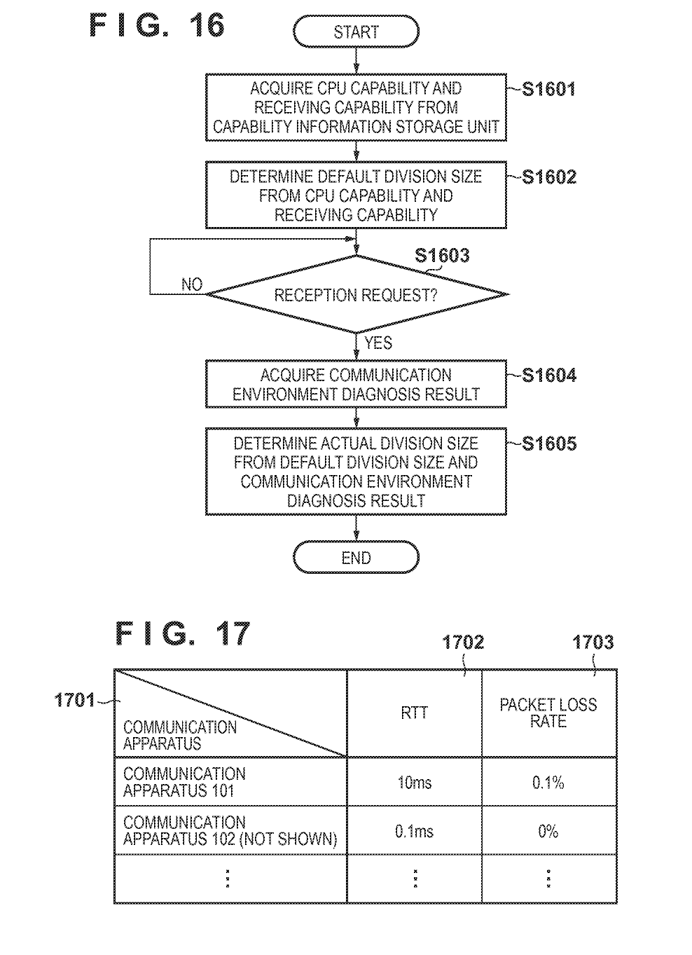

Next, explanation will be given for processing for determining the above described division size with reference to FIG. 16 and FIG. 17.

FIG. 16 is a flowchart for describing data division information determination processing that the data communication control module 301 of the communication apparatus 100 executes according to embodiments. Steps S1601-S1605 indicate the processing steps corresponding to a flow for the data division information determination processing that the data communication control module 301 of the communication apparatus 100 performs. Note, a program for executing the control procedure corresponding to these steps may be stored in any of the ROM 202, the RAM 203 or the HDD 204 of the communication apparatus 100, and by the CPU 201 executing the program, this processing is realized.

Firstly, in step S1601, the data communication control module 301 of the communication apparatus 100 acquires CPU capability information 310 and the receiving capability information 311 from the capability information storage unit 307. Next, the processing proceeds to step S1602, and the data communication control module 301 of the communication apparatus 100 determines a default value (DS1) of the division size transmitted to the communication apparatus 101 in step S804 of FIG. 8 from the acquired CPU capability information 310 and receiving capability information 311.

Specifically, firstly, a theoretical reception performance (P1) of the data communication execution module 302 of the communication apparatus 100 is calculated from the CPU capability information 310. For example, the frequency that the CPU capabilities indicate is made to be C Hertz, and the number of processing steps for the data communication execution module 302 of the communication apparatus 100 to perform reception processing of one packet is made to be K. In such a case, the processing time (T) required by the data communication execution module 302 of the communication apparatus 100 for reception processing of one packet is obtained with T=(K×1000)/C[milliseconds]. Accordingly, the theoretical value for the number of UDP packets that the UDP communication processing is capable of receiving in one second, and the theoretical communication performance P1 is N×1478 (BPS). Note, a datagram of one UDP packet is calculated as 1478 bytes.

The value of the theoretical communication performance P1 calculated in this way, and the value of communication rate information of the network I/F 207 maintained in the receiving capability information 311 are compared. In the case where P1 is larger, the data communication execution module 302 of the communication apparatus 100 is provided with the capability to be able to receive at a higher speed than the communication rate of the physical layer (the network I/F 207). For this reason, the value of the reception memory size of the data communication execution module 302 of the communication apparatus 100 maintained in the receiving capability information 311 is used as the default value (DS1) of the division size. Meanwhile, in a case where the communication rate of the network I/F 207 is larger, there is the possibility that reception processing of the data communication execution module 302 of the communication apparatus 100 will not be able to keep up, that the capacity of reception memory size will be exceeded, and that packet data loss will occur frequently. For this reason, the reception buffer size of the UDP communication module 304 of the communication apparatus 100 maintained in the receiving capability information 311 is used for the default value (DS1) of the division size.

When, in this way, the default value DS1 of the division size is determined in step S1602, the processing proceeds to step S1603, and the data communication control module 301 of the communication apparatus 100 waits for a request to receive to come from the communication apparatus 101. When, in step S1603, a request to receive is received, the processing proceeds to step S1604, and the data communication control module 301 of the communication apparatus 100 acquires the communication environment diagnosis result for communication with the communication apparatus 101 which is maintained beforehand.

FIG. 17 is a view for illustrating an example of a communication environment diagnosis result table according to embodiments.

The communication environment diagnosis result table is stored in one of the storage units (the ROM 202, the RAM 203, or the HDD 204) of the communication apparatus 100.

The communication environment diagnosis result table includes columns of communication apparatus information 1701, an RTT measurement result 1702, and a packet loss rate 1703 for a diagnosis partner. Here, for the communication apparatus 101, “10 ms” is stored for the RTT measurement result 1702, and “0.1%” is stored for the packet loss rate 1703.

In such a case, in step S1604, the corresponding communication environment diagnosis result related to the communication apparatus 101 is acquired. Then the processing proceeds to step S1605, and the data communication control module 301 of the communication apparatus 100, based on the acquired communication environment diagnosis result, determines the division size DS2 actually sent in notification to the communication apparatus 101.

Upon determination of DS2, firstly the packet loss rate is acquired from the communication environment diagnosis result, and the theoretical possible packet loss data size D is calculated. This value is calculated by (100/the packet loss rate)×1472 (the maximum payload for one packet in UDP). For example, in a case where the value of the packet loss rate is “0.1%”, in theory one packet loss may occur in one thousand packets, and the value of D is approximately 1.4 megabytes.

In the UDP communication processing according to the first embodiment, greatly reducing the occurrence of packet loss is very important in realizing high speed communication. So, in the case where the default value DS1 and the value of D are compared, and D is smaller, the value of D is used as the division size DS2 actually sent in notification to the communication apparatus 101. Meanwhile, in cases where the default value DS1 is smaller, the value of the default value DS1 is used as is as the division size DS2 actually sent in notification to the communication apparatus 101. Also, if the value of the packet loss rate is “0%”, the value of the default value DS1 is used as is as the division size DS2 actually sent in notification to the communication apparatus 101.

Furthermore, the value of the RTT is acquired from the communication environment diagnosis result table of FIG. 17. In cases where the value of the RTT is large (=the distance is large), a value resulting from the value of the division size DS2 further being multiplied by an adjustment rate is sent in notification to the communication apparatus 101. This is because the risk of packet loss occurring increases in cases where the distance is large This is because, hypothetically, there is the possibility that a packet loss will occur upon UDP communication this time, even if packet loss has not occurred much in the communication environment diagnosis.

By performing the above explained processing, sending in notification to the communication apparatus 101 an optimal division data size becomes possible at the communication apparatus 100. With this, it is possible to avoid the frequent occurrence of data loss, and to realize communication optimization.

As explained above, by the first embodiment, by dividing, at the transmitting side, transmission data into sub-data of a predetermined size and transmitting in units of sub-data items, it is possible to avoid situations in which the bandwidth on a network is occupied excessively.

Also, because the receiving side communication apparatus determines the method of division into the sub-data items, a situation in which the transmitting side sends, all at once, more data than the receiving side can receive in cases where the transmitting side is a high performance communication apparatus compared to the receiving side, can be avoided.

Furthermore, there is the effect that the transmitting side can initiate the retransmission processing quickly at the point in time when a data loss occurrence is detected.

Also, when the transmitting side is requested for retransmission, by retransmitting all of the sub-data items from the requested sequence number, even in an environment in which, for example, the data loss occurs frequently, the necessity for the receiving side to dispatch a large number of retransmission requests is eliminated. Because of this, since retransmission can be performed quickly without drastically reducing the communication performance, it becomes possible to realize guarantee of data arrival while capitalizing on the high speed of communication by UDP.

### Second Embodiment

Next, explanation will be given for a second embodiment according to the present invention. Note, because the configuration of the communication system and the configuration of the communication apparatuses 100 and 101 according to the second embodiment are the same as in the previously described first embodiment, explanation is omitted.

For the data that the communication apparatus 100 receives, the timing at which the retransmission request packet is transmitted, and the request content is not necessarily limited to the content shown in the previously described first embodiment, and there may be multiple arrangements. Furthermore, diagnosis of the communication environment for communication with the communication apparatus 101 may be performed beforehand, and the communication apparatus 100 may automatically select the one considered to be optimal, from out of a plurality of methods, in accordance with the diagnosis details.

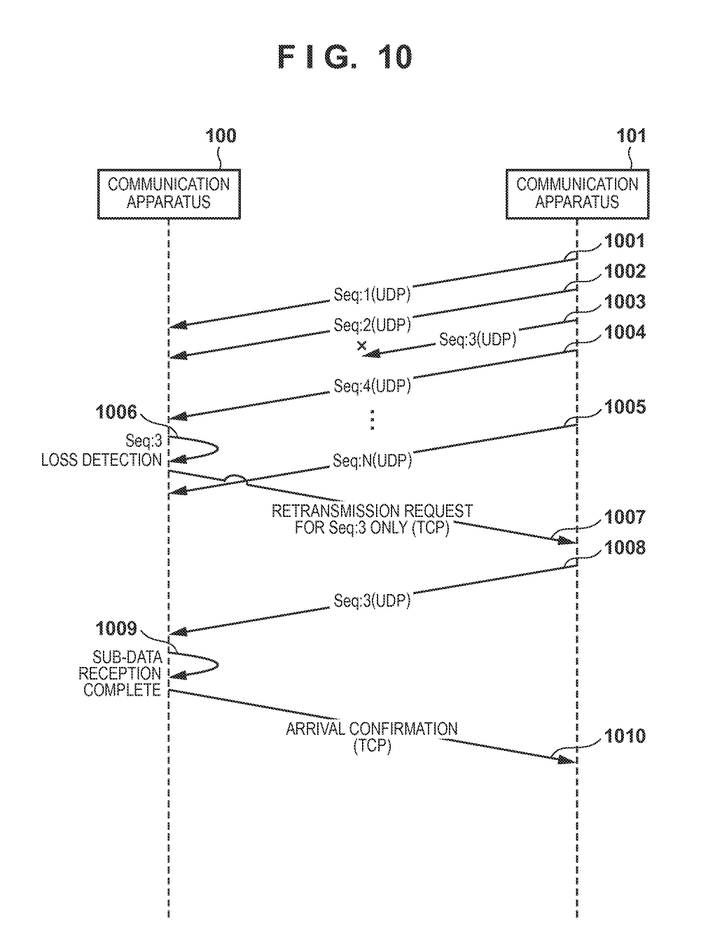

FIG. 10 is a sequence diagram for showing a retransmission request mode (pattern A) of the communication apparatus 100 according to a second embodiment of the present invention.

In the pattern A, when the communication apparatus 100 detects a loss in the sequence numbers of the received UDP packet data items, it immediately transmits the retransmission request packet to the communication apparatus 101 for that sequence number only.

The communication apparatus 101 transmits to the communication apparatus 100 the sub-data items for the UDP packet data items to which the sequence numbers 1-N are attached. Numeral 1001 denotes the UDP packet data item having the sequence number “1”. Numeral 1002 denotes the UDP packet data item having the sequence number “2”. Numeral 1003 denotes the UDP packet data item having the sequence number “3”, and numeral 1004 denotes the UDP packet data item having the sequence number “4”. Similarly, the packets continue, and are transmitted continuously until the UDP packet data 1005 with the sequence number “N”. Here, in the second embodiment, the UDP packet data item 1003 having the sequence number “3” is lost along the communication path and does not reach the communication apparatus 100.

Here, the communication apparatus 100 receives the UDP packet data 1004 having the sequence number “4” after the UDP packet data 1002 having the sequence number “2”, and cannot receive the UDP packet data item having the sequence number “3”. Here, at 1006, the communication apparatus 100 detects that the UDP packet data item having the sequence number “3” is lost along the way. Then, immediately, the retransmission request packet 1007 of the UDP packet data item having the sequence number “3” is transmitted to the communication apparatus 101.

The communication apparatus 101, having received the retransmission request packet 1007, retransmits the UDP packet data item 1008 having the sequence number “3” in accordance with the content of the request.

With this, the communication apparatus 100 receives the UDP packet data item 1008 having the sequence number “3”, and the reception of the desired sub-data has all completed (1009). In this way, the arrival confirmation packet 1010 is transmitted to the communication apparatus 101.

Because the retransmission request mode of pattern A is a simple method, in an environment in which the distance between the communication apparatus 100 and the communication apparatus 101 is short and packet loss does not occur much, there is an advantage that high speed retransmission can be performed without waste.

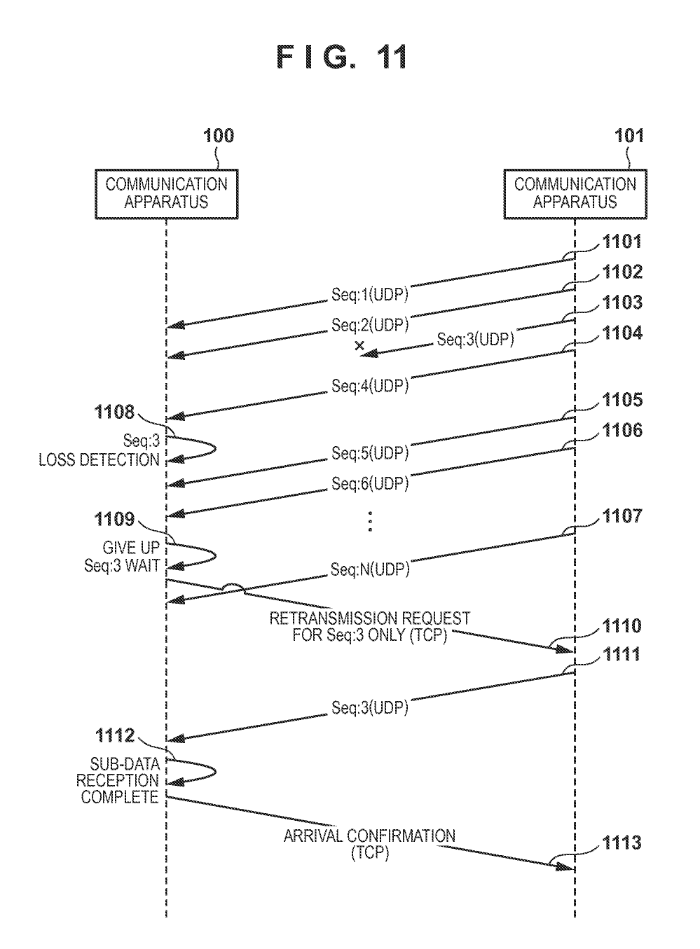

FIG. 11 is a sequence diagram for showing a retransmission request mode (pattern B) of the communication apparatus 100 according to a second embodiment of the present invention.

In general communication, there is no guarantee that packet data will necessarily arrive at the receiving side as is in the order the transmitting side sent it, and it is possible that the order of the packets may be mixed up along the communication path. For this reason, in pattern B, the communication apparatus 100 does not perform the retransmission request immediately even though it has detected a loss in the sequence numbers of the received UDP packet data items. In other words, after the sequence number loss is detected, the further reception of a predetermined number of UDP packet data items is awaited, and it is determined that the packet data of the lost sequence number does not exist even in these packet data items. In such a case, the retransmission request packet for the sequence number only is transmitted to the communication apparatus 101 at that point in time.

The communication apparatus 101 transmits to the communication apparatus 100 the sub-data items for the UDP packet data items to which the sequence numbers 1-N are attached. Numeral 1101 denotes the UDP packet data item having the sequence number “1”. Numeral 1102 denotes the UDP packet data item having the sequence number “2”. Numeral 1103 denotes the UDP packet data item having the sequence number “3”, numeral 1104 denotes the UDP packet data item having the sequence number “4”, numeral 1105 denotes the UDP packet data item having the sequence number “5”, and numeral 1106 denotes the UDP packet data item having the sequence number “6”. Similarly, the packets continue, and are transmitted continuously until the UDP packet data 1007 with the sequence number “N”. Here, in the second embodiment, the UDP packet data item 1103 having the sequence number “3” is lost along the communication path and does not reach the communication apparatus 100.

Here, the communication apparatus 100 receives the UDP packet data 1104 having the sequence number “4” after the UDP packet data 1102 having the sequence number “2”, and does not receive the UDP packet data item 1103 having the sequence number “3”. So, the communication apparatus 100, in numeral 1108, detects the sequence number “3” being lost along the way. In such a case, unlike with the pattern A shown in FIG. 10, the retransmission request packet is not transmitted at this point in time. After that, the UDP packet data 1105 having the sequence number “5” and the UDP packet data 1106 having the sequence number “6” are received, and at that point in time the UDP packet data item having the sequence number “3” is still not received. For this reason, in numeral 1109, waiting for the reception of the UDP packet data item having the sequence number “3” is given up on, and a retransmission request packet 1110 for the UDP packet data item having the sequence number “3” is transmitted to the communication apparatus 101. In the second embodiment, in numeral 1108, after a loss of the UDP packet data item having the sequence number “3” is detected, the further reception of two more packet data items is awaited, but the number of packets awaited may be some other number, and there is not necessarily a limitation that it be two packets.

The communication apparatus 101, having received the retransmission request packet 1110, retransmits a UDP packet data item 1111 having the sequence number “3” in accordance with the content of the request. Because of this, when the communication apparatus 100 receives the UDP packet data item 1111 having the sequence number “3”, it transmits the arrival confirmation packet 1113 to the communication apparatus 101 in numeral 1112 because all of the desired sub-data is received.

The retransmission request mode of pattern B, in an environment in which the distance is large between the communication apparatus 100 and the communication apparatus 101 and packet loss does not occur much, there is an advantage that situations in which unnecessary retransmission requests are performed can be avoided.

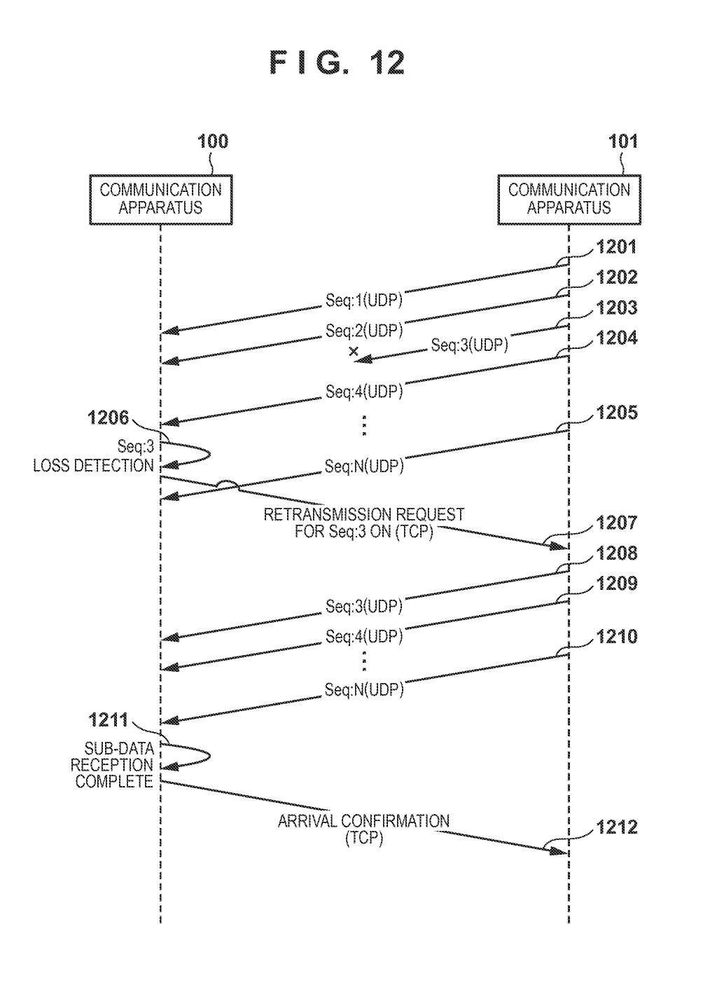

FIG. 12 is a sequence diagram for showing a retransmission request mode (pattern C) of the communication apparatus 100 according to the second embodiment of the present invention.

In pattern C, the communication apparatus 100 immediately transmits to the communication apparatus 101 a retransmission request packet for all of the sub-data from the sequence number on, when it detects a loss of a sequence number of the received UDP packet data items. In other words, FIG. 12 is a sequence diagram for showing the processing flow for the sub-data transmission subroutine of FIG. 6 and the sub-data reception subroutine of FIG. 9 in the first embodiment. Note, the packets and processing in 1201-1206 in FIG. 12 are the same as those of steps S1001-S1006 in FIG. 10 respectively.

The difference with FIG. 10 is that the communication apparatus 100, after the loss of the packet data having the sequence number “3” is detected in numeral 1206, transmits to the communication apparatus 101 a retransmission request packet 1207 for all of the UDP packet data items having sequence numbers from “3” onward.

The communication apparatus 101, having received the retransmission request packet 1207, retransmits UDP packet data items from the sequence number “3” on in accordance with the content of the request. In this example, the UDP packet data item 1208 having the sequence number “3” is retransmitted as well as the remaining UDP packet data 1209-1210. Here, numeral 1209 denotes the UDP packet data item having the sequence number “4”, and similarly, the continuing packet data is retransmitted, and data items until the UDP packet data 1210 having the sequence number “N” are retransmitted.

After that, when the communication apparatus 100, in numeral 1211, receives all of the desired sub-data, it transmits an arrival confirmation packet 1212 to the communication apparatus 101.

For the retransmission request mode of pattern C, irrespective of the distance between the communication apparatus 100 and the communication apparatus 101, when the environment is such that the rate of occurrence of packet loss is high, there is an advantage that the retransmission processing can be performed minimizing the number of times that the retransmission request packet from the communication apparatus 100 is retransmitted.

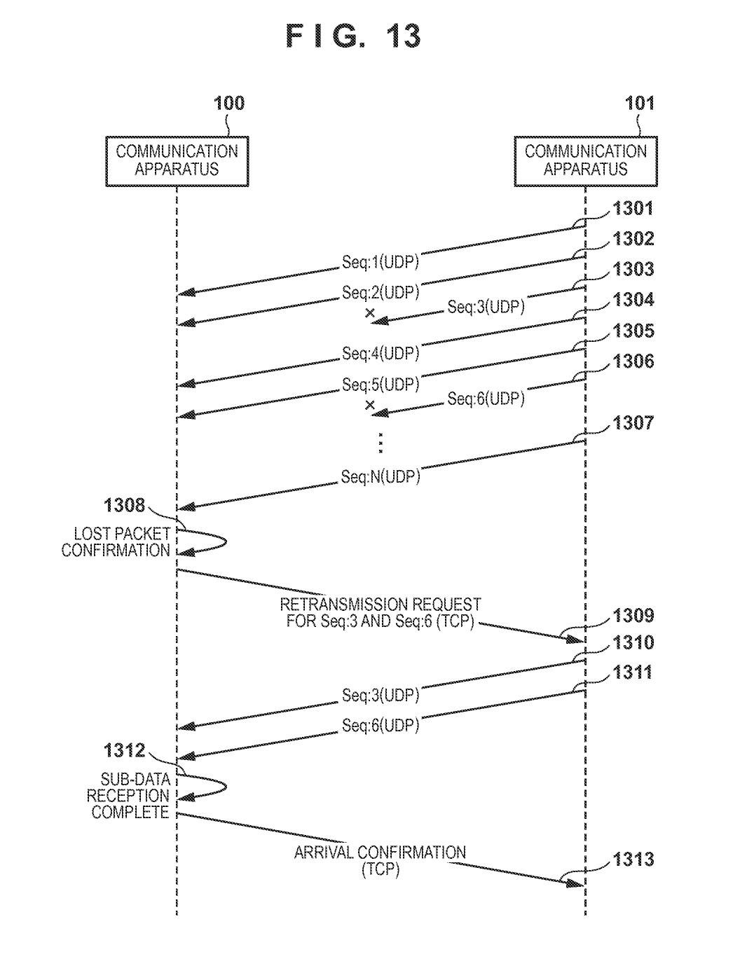

FIG. 13 is a sequence diagram for showing a retransmission request mode (pattern D) of the communication apparatus 100 according to the second embodiment of the present invention.

In the pattern D, the communication apparatus 100 postpones the transmission of the retransmission request until the last UDP packet data item is received. At the point in time when the last UDP packet data item is received, the lost sequence number is confirmed, and the communication apparatus 101 transmits a retransmission request packet for only the packet data of the lost sequence number.

Here, the communication apparatus 101 transmits to the communication apparatus 100 the sub-data items for the UDP packet data items to which the sequence numbers “1”-“N” are attached. Note, the packet data shown in 1301-1307 in FIG. 13 is the same as the packet data of 1101-1107 in FIG. 11 respectively. However, in this example, the UDP packet data items 1303 and 1306 are lost along the communication path, and do not reach the communication apparatus 100.

Here, the communication apparatus 100, in numeral 1308, determines whether or not a loss of a sequence number occurs at the point in time when the UDP packet data 1307 for the sequence number “N” is received. In this example, because the loss of the sequence numbers “3” and “6” is detected, a retransmission request packet 1309 is transmitted to the communication apparatus 101 for the UDP packet data items having sequence numbers “3” and “6”.

The communication apparatus 101, having received the retransmission request packet 1309, retransmits the UDP packet data item 1310 having the sequence number “3” and the UDP packet data item 1311 having the sequence number “6” in accordance with the content of the request.

Because of this, when the communication apparatus 100 receives the UDP packet data 1310 and 1311 in numeral 1312, an arrival confirmation packet 1313 is transmitted to the communication apparatus 101 because all of the desired sub-data have been received.

The retransmission request mode of pattern D is advantageous in an environment in which the distance is small between the communication apparatus 100 and the communication apparatus 101 and the frequency of packet loss is such that it does occur to a certain extent.

FIG. 14 is a functional block diagram for explaining a software configuration of the communication apparatus 100 according to the second embodiment. Note, each functional unit shown in FIG. 14 is realized by the CPU 201 executing the control programs of the communication apparatus 100.

The communication apparatus 100 has a data communication control module 1401, a data communication execution module 1402, a TCP communication module 1403, a UDP communication module 1404, a data storage module 1405 and a communication environment diagnosis module 1406.

The communication environment diagnosis module 1406 performs a diagnosis of a communication environment for communication with an external communication apparatus specified by a user in accordance with an instruction of the user input using the operation unit 206. Here the items for which the diagnosis is performed are the RTT for communication with the target communication apparatus (round trip delay time: Round Trip Time), and the packet loss rate. A predetermined number of existence confirmation packets having responsiveness are transmitted to the target communication apparatus, for example. The times that it takes from the transmission of the existence confirmation packet until the receipt of the corresponding reply packet is measured respectively, and the RTT is measured by calculating the average value. Also, by comparing the number of existence confirmation packets transmitted and the number of reply packets received, the packet loss rate can be obtained.

For example, the existence confirmation packet is an ICMP (Internet Control Message Protocol) Echo request packet, and the reply packet is an ICMP Echo reply packet. Alternatively, the existence confirmation packet and the reply packet may be of an independently created application using another protocol.

Other constituent elements 1401-1405 are the same as the constituent elements 301-305 shown in FIG. 3 explained in the previously described first embodiment, and so explanation is omitted.

In the communication apparatus 100 according to the second embodiment, a table may be maintained for determining which of the retransmission request mode patterns shown in the previously described FIGS. 10-13 to select in accordance with the communication environment diagnosis result.

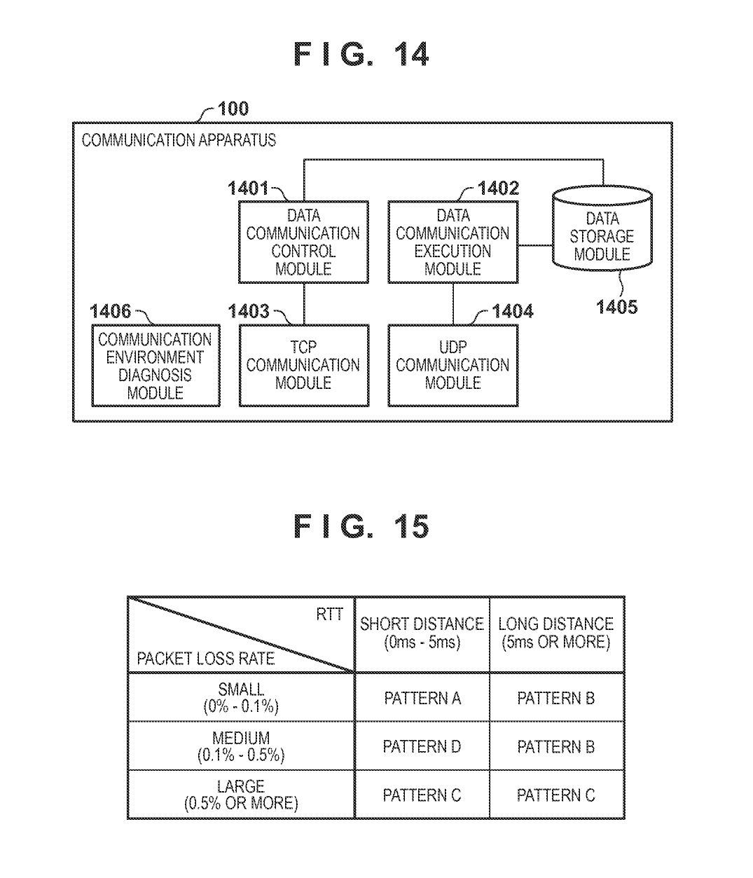

FIG. 15 is a view for showing an example of a retransmission request mode pattern table according to the second embodiment. The retransmission request mode pattern table is stored in one of the storage units (the ROM 202, the RAM 203, or the HDD 204) of the communication apparatus 100.

The retransmission request mode pattern table includes items for RTT and packet loss rate, is divided into whether the RTT is for a short distance or a long distance. Packet loss rate is divided into three stages of small, medium and large. For example, the result of a communication environment diagnosis by the communication environment diagnosis module 1406 shown in FIG. 14 determines that the distance is a short distance in a case where the RTT is between 0 ms and 5 ms and determines the distance to be a long distance when the RTT is 5 ms or greater. Similarly, the result of the communication environment diagnosis is that the packet loss rate is determined to be small when the packet loss rate is from 0% to 0.1%, the packet loss rate is determined to be medium when it is between 0.1% and 0.5%, and the packet loss rate is determined to be large if it is 0.5% or greater. The results of the categorization of RTT and packet loss rate, is that information as to which of the retransmission request mode patterns A-D shown in FIGS. 10-13 is selected is set in the cells of the table.

For example, in a case of a short distance, where packet loss does not occur much, because the simplest embodiment of the retransmission request mode is sufficient, pattern A of FIG. 10 in which retransmission of only the packet in question is requested immediately at the point in time when the packet loss is detected is set.

In a case where the packet loss rate is small or medium, and it is a long distance, because there is the possibility that cases in which arrival order of packets is mixed up will increase, pattern B of FIG. 11 in which the retransmission request is momentarily put off is set.

In addition, in cases where it is a short distance, and a packet loss is occurring at a moderate frequency (the packet loss rate is medium), because not much time is required for transfer of the retransmission packets, pattern D of FIG. 13 in which the retransmission request is not performed immediately, and the retransmission request is performed after all of the sub-data items is received is set.

Next, in a case where the packet loss rate is high, irrespective of the distance, pattern C of FIG. 12 is set in order to avoid a situation in which the number of times transmission of a retransmission request packet is performed increases too much.

The data communication execution module 1402 of the communication apparatus 100 according to the second embodiment acquires the communication environment diagnosis result for communication with the communication apparatus 101 from the communication environment diagnosis module 1406 before executing sub-data reception processing shown in FIG. 9. The result is compared against the retransmission request mode pattern table shown in FIG. 15, and which of the retransmission request mode patterns A-D is used is determined.

As explained above, by the second embodiment, it becomes possible to select automatically the most appropriate retransmission request mode in the environment for whatever kinds of conditions there are in the communication environment between the device and the communication partner. Because of this, it becomes possible to continuously maintain optimal communication performance in various communication environments.

Note, as in the first embodiment, the transmitting side communication apparatus 101 retransmitting collectively the UDP packet data item for a sequence number that is lost, and the packet data thereafter may be adapted to the case of FIG. 11.

The effects of embodiments explained above are summarized as follows.

By dividing, data for which transmission is desired into sub-data of a predetermined size and transmitting in units of sub-data items, it is possible to avoid situations in which the bandwidth on a network is occupied excessively.

Also, because the receiving side determines the method of division into the sub-data items, a situation in which the transmitting side sends, all at once, more data than the receiving side can receive, in a case where the transmitting side is a high performance communication apparatus compared to the receiving side, can be avoided.

Also, when a data loss is detected at the receiving side, because the retransmission request is transmitted to the transmitting side at a timing in accordance with the communication status, even in an environment in which data loss occurs frequently, for example, the receiving side will not dispatch a large number of retransmission requests.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-070455, filed Mar. 28, 2013 which is hereby incorporated by reference herein in its entirety.

What is claimed is:

1. A communication apparatus comprising:
a receiving unit configured to receive a packet, to which a sequence number is attached, from an external apparatus using UDP;
a determination unit configured to determine whether or not to make a request for a retransmission of a packet to the external apparatus based on the packet received by the receiving unit; and
a transmission unit configured to transmit a retransmission request using TCP to the external apparatus in a case where it is determined by the determination unit to make the request for the retransmission of the packet to the external apparatus,
wherein in a case where the transmission unit transmits the retransmission request to the external apparatus, the receiving unit receives, using UDP, a packet that the external apparatus retransmitted in accordance with the retransmission request, and
in a case where it is determined by the determination unit not to make a request for a retransmission of a packet to the external apparatus, the transmission unit transmits to the external apparatus, using TCP, a notification indicating that the packet has been normally received.

2. The communication apparatus according to claim 1, wherein the packet that the receiving unit receives is a packet corresponding to sub-data, and
in a case where the transmission unit transmits to the external apparatus, using TCP, the notification indicating that the packet has been normally received, the receiving unit receives from the external apparatus, using UDP, a packet corresponding to a next sub-data item.

3. The communication apparatus according to claim 2, further comprising:
a decision unit configured to decide a size of the sub-data by executing a negotiation with the external apparatus,
wherein the negotiation is executed using TCP.

4. The communication apparatus according to claim 1, wherein in a case where a loss of a sequence number occurs in a packet that the receiving unit receives, the determination unit determines to make a request for a retransmission of the packet to the external apparatus.

5. The communication apparatus according to claim 4, wherein in a case where it is determined by the determination unit to make a request for a retransmission of a packet to the external apparatus, the transmission unit transmits to the external apparatus, using TCP, a retransmission request including a sequence number for which a loss occurred.

6. The communication apparatus according to claim 5, wherein in a case where the transmission unit transmits to the external apparatus the retransmission request, the receiving unit receives, using UDP, a packet corresponding to the sequence number for which the loss occurred that the external apparatus retransmitted in accordance with the retransmission request.

7. The communication apparatus according to claim 5, wherein in a case where the transmission unit transmits to the external apparatus the retransmission request, the receiving unit receives, using UDP, a packet corresponding to sub-data from the sequence number for which the loss occurred that the external apparatus retransmitted in accordance with the retransmission request.

8. A communication apparatus comprising:
a transmission unit configured to attach a sequence number to a packet and to transmit the packet, using UDP, to an external apparatus; and
a receiving unit configured to receive, using TCP, from the external apparatus a reply corresponding to the packet transmitted by the transmission unit,
wherein in a case where the receiving unit received, from the external apparatus, a retransmission request requesting a retransmission of a packet, the transmission unit executes a retransmission of the packet using UDP.

9. The communication apparatus according to claim 8, wherein the packet that the transmission unit transmits is a packet corresponding to sub-data, and
in a case where the transmission unit transmits to the external apparatus, using TCP, the notification indicating that the packet has been normally received, the receiving unit receives from the external apparatus, using UDP, a packet corresponding to a next sub-data item.

10. The communication apparatus according to claim 9, further comprising:
a determination unit configured to determine a size of the sub-data by executing a negotiation with the external apparatus, wherein the negotiation is executed using TCP.

11. The communication apparatus according to claim 8, wherein in the retransmission request a sequence number for which a loss occurred is included, and
in a case where the receiving unit receives, using TCP, the retransmission request, the transmission unit transmits to the external apparatus a packet corresponding to the sequence number for which the loss occurred.

12. The communication apparatus according to claim 8, wherein in the retransmission request a sequence number for which a loss occurred is included, and
in a case where the receiving unit receives, using TCP, the retransmission request, the transmission unit transmits to the external apparatus a packet corresponding to sub-data from the sequence number for which the loss occurred.

13. A method of controlling a communication apparatus, the method comprising:
receiving a packet, to which a sequence number is attached, from an external apparatus using UDP;
determining whether or not to make a request for a retransmission of a packet to the external apparatus based on the packet received in the receiving; and
transmitting a retransmission request using TCP to the external apparatus in a case where it is determined in the determining to make the request for the retransmission of the packet to the external apparatus,
wherein in a case where the retransmission request is transmitted to the external apparatus, a packet that the external apparatus retransmitted in accordance with the retransmission request is received using UDP, and
in a case where it is determined not to make a request for a retransmission of a packet to the external apparatus, a notification indicating that the packet was normally received is transmitted to the external apparatus using TCP.

14. A non-transitory computer-readable storage medium storing a program for causing a computer to function as the communication apparatus according to claim 1.

15. A method of controlling a communication apparatus, the method comprising:
attaching a sequence number to a packet and transmitting the packet, using UDP, to an external apparatus; and
receiving, using TCP, from the external apparatus a reply corresponding to the packet transmitted in the transmitting, wherein in a case where a retransmission request requesting a retransmission of a packet is received from the external apparatus, a retransmission of a packet using UDP is executed.

16. A non-transitory computer-readable storage medium storing a program for causing a computer to function as the communication apparatus according to claim 8.
